(19) United States
(12) Patent Application Publication
(10) Pub. No.: US 2004/0136077 A1
(43) Pub. Date: Jul. 15, 2004

(54) Light guide plate having diffusion dots with microlenses

(76) Inventors: Charles Leu, Fremont, CA (US); Tai-Cheng Yu, Tu-Chen (TW); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/744,178

(22) Filed: Dec. 22, 2003

(30) Foreign Application Priority Data
Dec. 20, 2002 (TW) 91220818

(51) Int. Cl. G02B 5/02

(52) U.S. Cl. 359/599; 362/31

(57) ABSTRACT

A light guide plate (20) providing illumination for a liquid crystal display panel includes a light incident surface (23) for receiving light beams from a light source, an emission surface (21) for emitting the light beams, and a bottom surface (25) opposite to the emission surface. A plurality of diffusion dots (27) is formed on the bottom surface for scattering the light beams. Each diffusion dot has a concave surface (273) forming a plurality of microlenses (275) thereon. The light guide plate provides a high brightness and a uniform illumination for the liquid crystal display panel.

### BACKGROUND OF THE INVENTION

1. Field of the Invention

The present invention relates to a light guide plate for a surface light source unit, and especially to a light guide plate with diffusion dots configured to provide high brightness and uniform illumination.

2. Description of Prior Art

Recently, color liquid crystal display devices have been widely used in various applications, such as in portable personal computers, liquid crystal display televisions, video built-in type liquid crystal televisions, etc. Because the liquid crystal display is not a self-illumining device, a surface light source including a light guide plate for providing illumination is needed. In such a surface light source unit, the light guide plate is formed from a planar transparent member such as an acrylic resin plate or the like. Light beams emitted from a light source, such as a cold cathode fluorescent lamp (CCFL) or a light emitting diode (LED), are transmitted through a side surface (light incidence surface) into the light guide plate. One portion of the incident light beams is reflected by a bottom surface and emitted through an emission surface. A remaining portion of the light beams is emitted from the bottom surface to an outside of the light guide plate, where said light beams are reflected by a reflective plate disposed under the light guide plate back into the light guide plate. A plurality of light reflection dots having a light scattering function is formed on the bottom surface, to increase the uniformity of illumination provided by the light guide plate.

FIG. 8 shows a conventional light guide plate 10. The light guide plate 10 includes a bottom surface 105 forming a plurality of light reflection dots 107 thereon. The light reflection dots 107 are hemispherical. Alternatively, the light reflection dots 107 can be cubic, cylindrical, etc. The light reflection dots 107 are arranged on the bottom surface 105 uniformly. Alternatively, sizes of the light reflection dots 107 can progressively vary according to their distance from a light source (not shown). However, the light reflection dots 107 can only make the light beams emit from an emission surface opposite to the bottom surface 105 evenly. The light reflection dots 107 cannot enhance the brightness of the light guide plate 10. In order to enhance the brightness of the light guide plate 10, a prism plate (not shown) disposed on the light guide plate 10 is needed. This makes the corresponding surface light source unit (not shown) more complicated and costlier.

It is desired to provide a light guide plate to solve the above-mentioned problems.

### SUMMARY OF THE INVENTION

An object of the present invention is to provide a light guide plate which provides high brightness and uniform illumination for a liquid crystal display.

To achieve the above object, a light guide plate of the present invention includes a light incidence surface for receiving light beams, a top emission surface for emitting the light beams, a bottom surface opposite to the top emission surface, and a plurality of diffusion dots formed on the bottom surface for scattering the light beams. The diffusion dots each have a concave surface opposite to the bottom surface, on which a plurality of microlenses is formed. The concave surface defines a recess having a rectangular pyramidal form, whose depth is equal to or less than a height of the diffusion dot. The microlenses are convex, and protrude outwardly from the concave surface. A radius of curvature of each microlens is in the range from 5 micrometers to 50 micrometers. The diffusion dots provide the light guide plate with high brightness and uniform illumination.

Other objects, advantages, and novel features of the present invention will become more apparent from the following detailed description when taken in conjunction with the accompanying drawings, in which:

### BRIEF DESCRIPTION OF THE DRAWINGS

FIG. 1 is an isometric view of a light guide plate according to the present invention.

FIG. 2 is a side elevation of the light guide plate of FIG. 1;

FIG. 3 is a bottom elevation of the light guide plate of FIG. 1;

FIG. 4 is an enlarged, isometric view of one diffusion dot of the light guide plate of FIG. 1;

FIG. 5 is a bottom elevation of the diffusion dot of FIG. 4;

FIG. 6 is a bottom elevation of the diffusion dot of FIG. 4, but not showing microlenses thereof;

FIG. 7 is an isometric view of a diffusion dot of a light guide plate according to an alternative embodiment of the present invention; and

FIG. 8 is a bottom elevation of a conventional light guide plate.

### DETAILED DESCRIPTION OF THE INVENTION

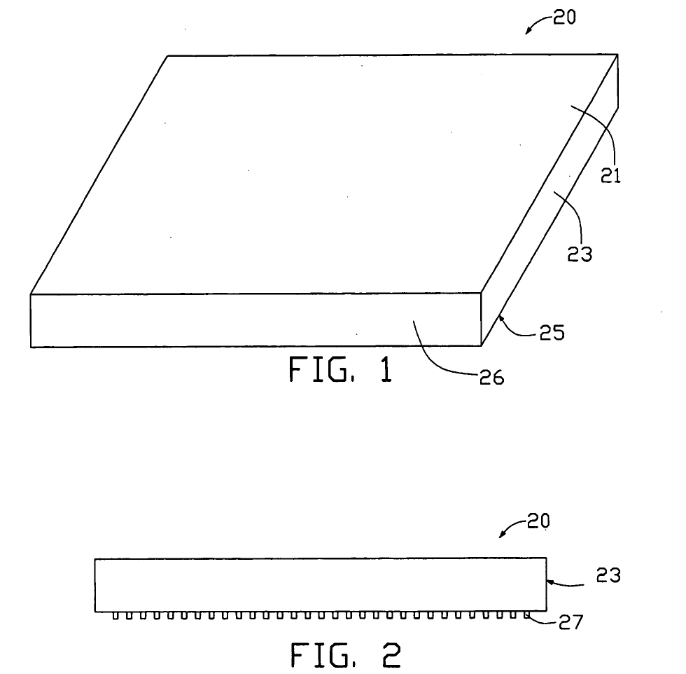

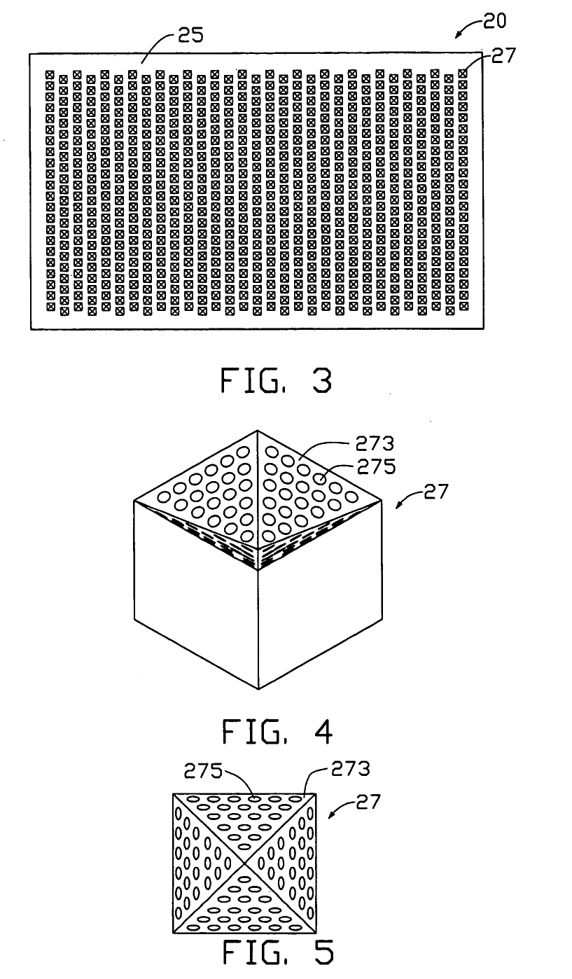

Referring to FIGS. 1 through 3, a rectangular light guide plate 20 comprises a light incidence surface 23, a bottom surface 25 perpendicular to the light incidence surface 23, a top emission surface 21 opposite to the bottom surface 25 and a plurality of side surfaces 26. The light incidence surface 23 receives light beams from a light source (not shown) adjacent thereto, and the top emission surface 21 emits the light beams for illuminating a liquid crystal display panel (not shown).

In the present invention, the light guide plate 20 is made of polymethyl methacrylate (PMMA) resin. Alternatively, transparent glass or another kind of synthetic resin may be used to make the light guide plate 20. A thickness of the light guide plate 20 is preferably in the range from approximately 1 millimeter to 10 millimeters.

A plurality of diffusion dots 27 is formed on the bottom surface 25. The diffusion dots 27 are arranged on the bottom surface 25 in a generally uniform array of rows and columns. The diffusion dots 27 in each row of the array are arranged alternately with respect to the diffusion dots 27 in each adjacent row of the array. Similarly, the diffusion dots 27 in each column of the array are arranged alternately with respect to the diffusion dots 27 in each adjacent column of the array. The diffusion dots 27 may progressively increase in size with increasing distance away from the light incidence surface 23, in order to make the light beams emit uniformly from the emission surface 321. A height of the diffusion dots 27 is between 0.5 micrometer and 100 micrometers, and preferably 50 micrometers.

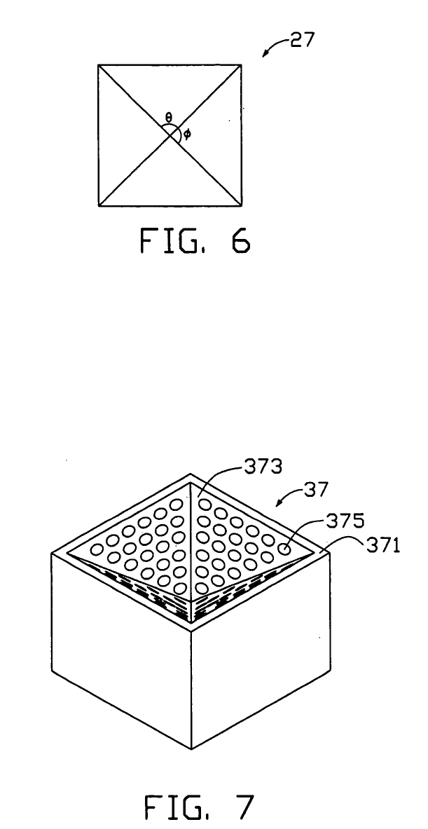

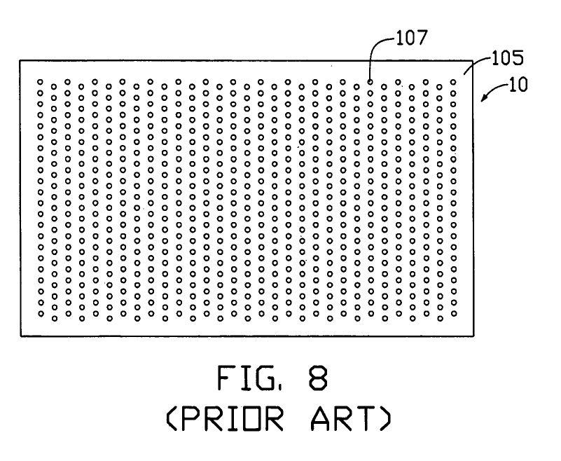

Turning to FIGS. 4 and 5, each diffusion dot 27 has a concave surface 273 opposite to the bottom surface 25. The concave surface 273 comprises four triangular surfaces (not labeled) having a same vertex. The concave surface 273 has rectangular pyramidal form, and defines a recess (not labeled). A depth of the recess is equal to or less than the height of the diffusion dot 27. A plurality of microlenses 275 is formed in the recess. Each microlens 275 is convex, and protrudes outwardly from the concave surface 273. A radius of curvature of each microlens 275 is in the range from 5 micrometers to 50 micrometers. FIG. 6 is a bottom elevation of one diffusion dot 27, but not showing the microlenses 275 thereof. Angle θ and angle Φ are two vertex angles of the two adjacent triangular surfaces, and are equal to each other. Alternatively, the angles θ and Φ may be different. Angle θ is in the range from 30 degrees to 60 degrees, and is preferably 50 degrees. The diffusion dots 27 provide the light guide plate 20 with high brightness and uniform illumination.

In operation, a light source (not shown) adjacent to the light incidence surface 23 emits light beams into the light guide plate 20. The light beams are reflected by the diffusion dots 27 on the bottom surface 25, and emit through the top emission surface 21. When the light beams reach the microlenses 275, they are collected by the microlenses 275 and are subsequently emitted from the top emission surface 21.

FIG. 7 shows a diffusion dot 37 in accordance with an alternative embodiment of the present invention. The diffusion dot 37 is similar to the above-described diffusion dot 27. The diffusion dot 37 is cubic, and comprises a distal surface 371, a recess 373, and a plurality of microlenses 375 formed in the recess 373.

The light guide plate according to the present invention has the following advantages. The provision of the microlenses 275, 375 on the diffusion dots 27, 37 makes it possible to effectively collect the light beams, so that the brightness of the light guide plate 20 is enhanced. If a surface light source unit adopts the light guide plate 20 of the present invention, prism plates are not necessarily required. The structure of the surface light source unit is simplified, and the cost of the surface light source unit can be reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate comprising:
a light incidence surface for receiving light beams;
an emission surface for emitting the light beams;
a bottom surface opposite to the emission surface;
a plurality of diffusion dots formed on the bottom surface, each of the diffusion dots having a concave surface opposite to the bottom surface for scattering the light beams; and
a plurality of microlenses formed on the concave surface.

2. The light guide plate as claimed in claim 1, wherein a radius of curvature of each of the microlenses is in the range from 5 micrometers to 50 micrometers.

3. The light guide plate as claimed in claim 1, wherein the diffusion dots are substantially cubic.

4. The light guide plate as claimed in claim 1, wherein the concave surface defines a recess.

5. The light guide plate as claimed in claim 4, wherein the concave surface is pyramidal.

6. The light guide plate as claimed in claim 1, wherein a height of the diffusion dots is in the range from 0.5 micrometers to 100 micrometers.

7. The light guide plate as claimed in claim 4, wherein a depth of the recess is equal to a height of the diffusion dots.

8. The light guide plate as claimed in claim 4, wherein a depth of the recess is less than a height of the diffusion dots.

9. The light guide plate as claimed in claim 1, wherein the diffusion dots are cubic, cylindrical, hemispherical, and/or ellipsoid.

10. The light guide plate as claimed in claim 1, wherein the diffusion dots are arranged on the bottom surface in a generally uniform array of rows and columns, and the diffusion dots in each row of the array are arranged alternately with respect to the diffusion dots in each adjacent row of the array.

11. The light guide plate as claimed in claim 1, wherein sizes of the diffusion dots progressively increase with increasing distance away from the light incident surface.

12. A light guide plate comprising:
a light incidence surface for receiving light beams;
an emission surface for emitting the light beams;
a bottom surface opposite to the emission surface;
a plurality of diffusion dots formed on the bottom surface, each of the diffusion dots defining an opening opposite to the bottom surface and comprising a plurality of microlenses in the opening for scattering the light beams.

13. The light guide plate as claimed in claim 12, wherein the opening is substantially pyramidal.

14. The light guide plate as claimed in claim 12, wherein a radius of curvature of each of the microlenses is in the range from 5 micrometers to 50 micrometers.

15. The light guide plate as claimed in claim 12, a height of the diffusion dots is in the range from 0.5 micrometers to 100 micrometers.

16. The light guide plate as claimed in claim 12, wherein a depth of the opening is equal to a height of the diffusion dots.

17. The light guide plate as claimed in claim 12, wherein a depth of the opening is less than a height of the diffusion dots.

18. The light guide plate as claimed in claim 12, wherein the diffusion dots are cubic, cylindrical, hemispherical, and/or ellipsoid.

19. The light guide plate as claimed in claim 12, wherein the diffusion dots are arranged on the bottom surface in a generally uniform array of rows and columns, and the diffusion dots in each row of the array are arranged alternately with respect to the diffusion dots in each adjacent row of the array.

20. A light guide plate comprising:
a light emitting surface;
a bottom surface opposite to said light emitting surface; and
a plurality of diffusion points formed on said bottom surface; wherein
each of said diffusion dots defines at least one inwardly offset surface, relative to the bottom surface, with a plurality of convex type microlenses formed thereon.
